(19) United States
(12) Patent Application Publication
(10) Pub. No.: US 2024/0320262 A1
(43) Pub. Date: Sep. 26, 2024

(54) SYSTEM AND METHOD FOR AGGREGATING EVENT-RELATED ARTIFACTS AND MAKING ARTIFACTS ACCESSIBLE

(71) Applicant: Bijal C. MODI, Bridgewater, NJ (US)

(72) Inventor: Bijal C. MODI, Bridgewater, NJ (US)

(21) Appl. No.: 18/606,652

(22) Filed: Mar. 15, 2024

(30) Foreign Application Priority Data
Mar. 24, 2023 (IN) 202311020934

(51) Int. Cl. G06F 16/483; G06F 16/41; H04L 67/50

(52) U.S. Cl. CPC G06F 16/483; G06F 16/41; H04L 67/535

(57) ABSTRACT

The present invention relates to a system(100) and method for aggregating event-related artifacts and making artifacts accessible. The present invention includes a cloud server(102), an organizer computing device(110), and an attendee computing device(122). The system processing unit(106) automatically archive and share event-related artifacts created by all the attendees and organizers. The system processing unit(106) automatically provides real-time information to event attendees and organizers regarding the check-in of the attendee. The organizer computing device(110) communicates with the system processing unit(106) to invite the attendee and hire vendors for the management of the event. The system processing unit(106) organizes the event-related artifacts and shares them with the attendee and non-attendee in chronological order with respect to uploader, popularity and presence of self in the media.

### FIELD OF INVENTION

The present invention relates to a system and method for archiving event based articrafts and more specifically present invention relates to a system and method for aggregating event-related artifacts and making artifacts accessible to attendees and event organizers.

### BACKGROUND OF THE INVENTION

We attend many events and click pictures and videos of the stores it in our phone or computer in disorganized manner. Also, in case large events the pictures become more disorganized and we could not get pictures of our known who attended the event. There following such problems related to even that is cited below. Who all are invited?—Status of all invitees (how many have been invited, how many are planning to attend, how many may not be able to attend, how many actually end up attending). how many of the attendees have ‘checked in’ at the venue?. How to share the pics/videos taken with others?—Current practice of taking pictures with mobile camera and then manually sharing/air dropping/uploading to shared drive (e.g. dropbox, one drive, google drive, etc.) is cumbersome and not everyone follows, leaving out large number of media recorded during the event from view by others. How much memory is taken by the media?—In most events, people record a large number of photos, and short videos which occupy their mobile phone's memory which with time gets clogged with unrelated photos. How to bubble up the most liked media?—When there is a large number of media, it is difficult to sort them by time taken (chronological order), or the most popular getting bubbled up using the current way of sharing . . . . Are there any services to smoothen out events?—This could be as simple as transportation, booking venue to getting event organiser, return gifts, printed invitations, etc. Inviting multiple persons in short interval of time.

In the prior art, the existing invention does not generate provide the checking information of attendee. The existing inventions are unable to organize the multiple images as per each attendee requirements. The existing invention does not the user in managing event smoothly. The present invention is capable of overcoming all drawbacks of the existing inventions hence there is a need for the present invention.

### OBJECTIVE OF THE INVENTION

The main objective of the present invention is to provide to a system and method for aggregating event-related artifacts and making artifacts accessible to attendees and event organizers with a single touch on the mobile screen

Another objective of the present invention is to develop a system that helps organizers to quickly send the invitation to the attendee.

Yet another objective of the present invention is to develop a system that automatically check-in the attendee based on the their GPS location and notify the other attendee about the arrival of the other attendees.

Yet another objective of the present invention is to develop a system that help organizer to understand the mood of the crowd in the event.

Further objectives, advantages, and features of the present invention will become apparent from the detailed description provided herein below, in which various embodiments of the disclosed invention are illustrated by way of example.

### SUMMARY OF THE PRESENT INVENTION

The present invention relates to a system and method for aggregating event-related artifacts and making artifacts accessible. The present invention includes a cloud server, an organizer computing device, and an attendee computing device. The cloud server includes cloud server memory, and a system processing unit. The cloud server memory stores server computer-readable instructions, the credentials of an attendee that is invited to the event, event-related artifacts created by all the attendees for archiving and sharing, comments and chats of the attendee, and an artificial intelligence-based model. The system processing unit executes server-computer-readable instructions to train an artificial intelligence-based model. The system processing unit executes server-computer-readable instructions to automatically archive and share event-related artifacts created by all the attendees. The system processing unit executes server-computer-readable instructions also to automatically provide real-time information to event attendees and organizers regarding the check-in of attendees in the event. The organizer computing device is connected to the system processing unit of the cloud server. The organizer computing device communicates with the system processing unit to invite the attendee and hire vendors for the management of the event. The organizer computing device includes an organizer display unit, and an organizer camera. The organizer display unit is the interface between the cloud server and the organizer, the organizer display unit displays all the data that is being communicated to the organizer computing device. The organizer computing device creates event-related artifacts through the organizer camera that is automatically uploaded to the cloud server memory. The system processing unit organize the event-related artifacts and shares them with the attendee and non-attendee in chronological order with respect to uploader, popularity and presence of self in the media The attendee computing device is connected to the system processing unit of the cloud server. The attendee computing device communicates with the system processing unit to receive invitation and event locations from the organizer computing device. The attendee computing device includes an attendee display unit, an attendee camera. The attendee display unit is the interface between the cloud server and the attendee. The attendee display unit displays all the event-related artifacts that are being communicated to the attendee computing device. The attendee creates event-related artifacts through the attendee camera that are automatically uploaded to the cloud server memory. The system processing unit organizes the event-related artifacts and shares them with attendees and non-attendee, and organizers in chronological order with respect to uploader, popularity and presence of self in the media.

Another advantage of the present invention is that the present invention provides a system and method for aggregating event-related artifacts and making artifacts accessible to attendees and event organizers.

Yet another advantage of the present invention is that the present invention helps organizers to quickly send the invitation to the attendee.

Yet another advantage of the present invention is that the present invention automatically check-in the attendee based on the their GPS location and notify the other attendee about the arrival of the other attendees.

Yet another advantage of the present invention is that the present invention uses machine learning that learns from chat of the attendee the mood of the crowd in the event.

Further objectives, advantages, and features of the present invention will become apparent from the detailed description provided herein below, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates the block diagram of the present invention

FIG. 2 illustrates a method of creating, sharing, and archiving event-related artifacts

FIG. 3 illustrates a method of inviting attendees.

FIG. 4 illustrates a method of sharing information of check-in by the attendee in real-time.

FIG. 5 illustrates a method of getting feedback on the event in real-time.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definition

The terms “a” or “an”, as used herein, are defined as one or as more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”. Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation. The term “or” as used herein is to be interpreted as an inclusive or meaning any one or any combination. Therefore, “A, B or C” means any of the following: “A: B; C: A and B: A and C: B and C: A, B and C”. An exception to this definition will occur only when a combination of elements, functions, steps or acts are in some way inherently mutually exclusive.

As used herein, the term “one or more” generally refers to, but is not limited to, singular as well as the plural form of the term.

The drawings featured in the figures are for the purpose of illustrating certain convenient embodiments of the present invention and are not to be considered as limitation thereto. The term “means” preceding a present participle of an operation indicates the desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

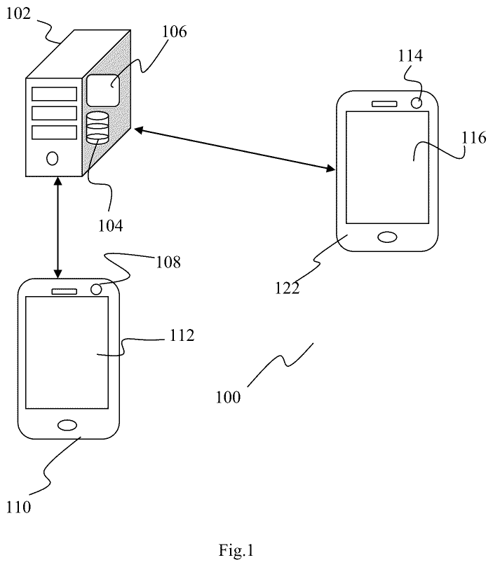

FIG. 1 illustrates a system(100) for aggregating event-related artifacts and making artifacts accessible. The present invention includes cloud server(102), an organizer computing device(110), an attendee computing device(122). The cloud server(102) includes cloud server memory(104), and a system processing unit(106). The organizer computing device(110) is connected to the system processing unit(106) of the cloud server(102). The organizer computing device(110) includes an organizer display unit(112), and an organizer camera(108). The attendee computing device(122) is connected to the system processing unit(106) of the cloud server(102). The attendee computing device(122) includes an attendee display unit(114), and an attendee camera (116).

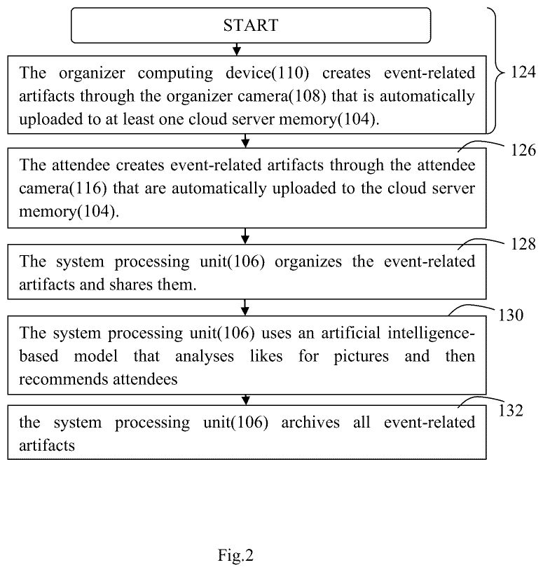

FIG. 2 illustrates a method of creating, sharing, and archiving event-related artifacts, In step(124), the organizer computing device(110) creates event-related artifacts through the organizer camera(108) that is automatically uploaded to at least one cloud server memory(104). In step(126), the attendee creates event-related artifacts through the attendee camera(116) that are automatically uploaded to the cloud server memory(104). In step (128), the system processing unit(106) organizes the event-related artifacts and shares them with attendees and non-attendee, and the organizer in chronological order. In step (130), the system processing unit(106) uses an artificial intelligence-based model that analyses likes for pictures and then recommends attendees with the same categories of picture. In step (132), the system processing unit(106) archives all event-related artifacts including chat and comments in a single place, that is in the cloud server memory(104). The system(100), allows single-touch capturing, uploading, and sharing of event-related artifacts among attendees, non-attendee, and organizers and storing the media in the cloud in chronological order with respect to uploader, popularity and presence of self in the media

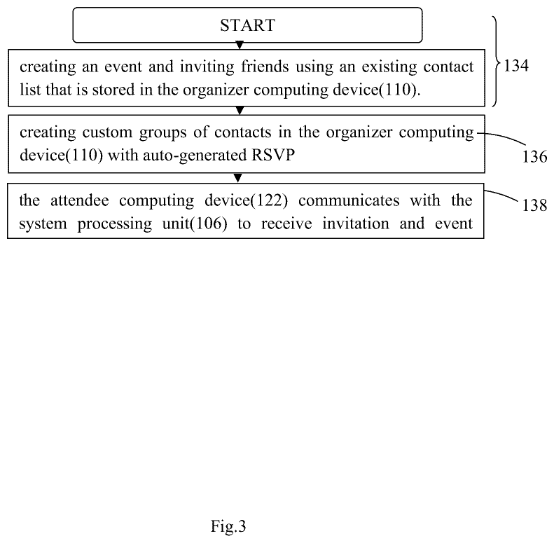

FIG. 3 illustrates a method of inviting attendees. In step (134), creating an event and inviting friends using an existing contact list that is stored in the organizer computing device(110). In step (136), creating custom groups of contacts in the organizer computing device(110) with auto-generated RSVP (“Respond, if you please”) workflow. In step (138), the attendee computing device(122) communicates with the system processing unit(106) to receive invitation and event location from the organizer computing device(110).

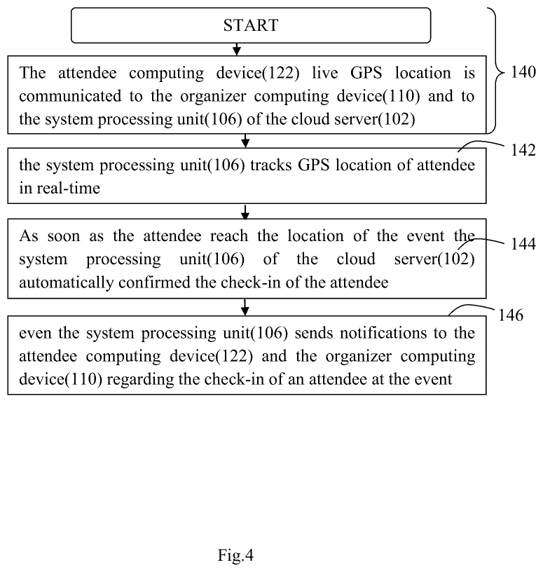

FIG. 4 illustrates a method of sharing information of check-in by the attendee in real-time. In step (140), the attendee computing device(122) live GPS location is communicated to the organizer computing device(110) and to the system processing unit(106) of the cloud server(102). In step (142), the system processing unit(106) tracks GPS location of attendee in real-time. In step (144), as soon as the attendee reach the location of the event the system processing unit(106) of the cloud server(102) automatically confirmed the check-in of the attendee. In step (146), even the system processing unit(106) sends notifications to the attendee computing device(122) and the organizer computing device(110) regarding the check-in of an attendee at the event.

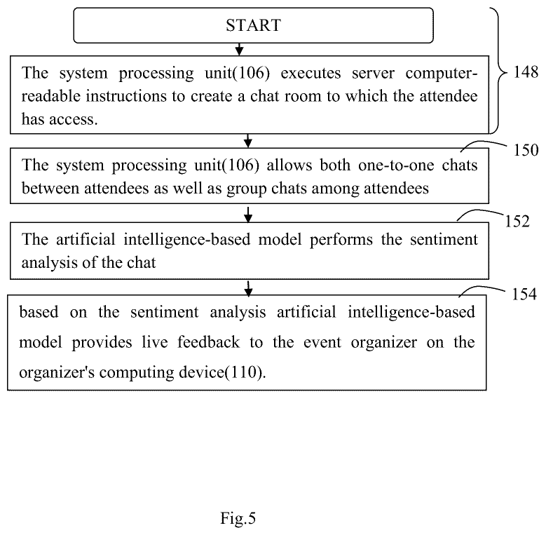

FIG. 5 illustrates a method of getting feedback on the event in real-time. In step(148), the system processing unit(106) executes server computer-readable instructions to create a chat room to which the attendee has access. In step(150), the system processing unit(106) allows both one-to-one chats between attendees as well as group chats among attendees. In step(152), the artificial intelligence-based model performs the sentiment analysis of the chat. In step(154), based on the sentiment analysis artificial intelligence-based model provides live feedback to the event organizer on the organizer's computing device(110).

The present invention relates to a system and method for aggregating event-related artifacts and making artifacts accessible. The present invention includes a cloud server, an organizer computing device, and an attendee computing device. The cloud server includes cloud server memory, and a system processing unit. The cloud server memory stores server computer-readable instructions, the credentials of an attendee that is invited to the event, event-related artifacts created by all the attendees for archiving and sharing, comments and chats of the attendee, and an artificial intelligence-based model. The system processing unit executes server-computer-readable instructions to train an artificial intelligence-based model. The system processing unit executes server-computer-readable instructions to automatically archive and share event-related artifacts created by all the attendees. The system processing unit executes server-computer-readable instructions also to automatically provide real-time information to event attendees and organizers regarding the check-in of attendees in the event. The organizer computing device is connected to the system processing unit of the cloud server. The organizer computing device communicates with the system processing unit to invite the attendee and hire vendors for the management of the event. The organizer computing device includes an organizer display unit, and an organizer camera. The organizer display unit is the interface between the cloud server and the organizer, the organizer display unit displays all the data that is being communicated to the organizer computing device. The organizer computing device creates event-related artifacts through the organizer camera that is automatically uploaded to the cloud server memory. The system processing unit organize the event-related artifacts and shares them with the attendee and non-attendee in chronological order with respect to uploader, popularity and presence of self in the media. The attendee computing device is connected to the system processing unit of the cloud server. The attendee computing device communicates with the system processing unit to receive invitation and event locations from the organizer computing device. The attendee computing device includes an attendee display unit, an attendee camera. The attendee display unit is the interface between the cloud server and the attendee. The attendee display unit displays all the event-related artifacts that are being communicated to the attendee computing device. The attendee creates event-related artifacts through the attendee camera that are automatically uploaded to the cloud server memory. The system processing unit organizes the event-related artifacts and shares them with attendees and non-attendee, and organizers in chronological order with respect to uploader, popularity and presence of self in the media. Herein, the system processing unit executes server computer-readable instructions to create a chat room for allowing both one-to-one and attendee group chats, that provides live feedback to the event organizer through real-time sentiment analysis of the chat by artificial intelligence-based model. Herein, the system, allows single touch capturing, uploading, and sharing of event-related artifacts among attendees, and non-attendee, and organizing and storing the media in the cloud in chronological order with respect to uploader, popularity and presence of self in the media. Herein, the system processing unit uses an artificial intelligence-based model that notes the average arrival time of attendees in comparison with attendees' location and recommends the best location for the convenience of attendees. Herein, the system processing unit uses an artificial intelligence-based model that analyses likes for pictures and then recommends attendees with the same categories of pictures. In an embodiment, the organizer computing device and the attendee computing device are, including but not limited to, a desktop computer, a laptop, a tab, a smartphone, and, a smartwatch. In an embodiment, the artificial intelligence-based model is trained from the data stored in the cloud server memory that has been extracted from the organizer computing device and the attendee computing device/In an embodiment, event-related artifacts are, including but limited to, a photo, video, short video reels, chats, and comments, video call records. In an embodiment, artificial intelligence-based personal assistance models is a machine-learning models.

In an embodiment, the present invention relates to a system and method for aggregating event-related artifacts and making artifacts accessible. The present invention includes one or more cloud servers, an organizer computing device, one or more attendee computing devices. The one or more cloud servers include one or more cloud server memory, and a system processing unit. The one or more cloud server memory store server computer-readable instructions, the credentials of an attendee that is invited to the event, event-related artifacts created by all the attendees for archiving and sharing, comments and chats of the attendee, and an artificial intelligence-based model. The system processing unit executes server-computer-readable instructions to train an artificial intelligence-based model. The system processing unit executes server-computer-readable instructions to automatically archive and share event-related artifacts created by all the attendees. The system processing unit execute server-computer-readable instructions also to automatically provide the real-time information to event attendees and organizers regarding the check-in of attendee in the event. The organizer computing device is connected to the system processing unit of the one or more cloud servers. The organizer computing device communicates with the system processing unit to invite the attendee and hire vendors for the management of the event. The organizer computing device includes an organizer display unit, and an organizer camera. The organizer display unit is the interface between the one or more cloud servers and the organizer, the organizer display unit displays all the data that is being communicated to the organizer computing device. The organizer computing device creates event-related artifacts through the organizer camera that is automatically uploaded to the one or more cloud server memory. The system processing unit organize the event-related artifacts and shares them with the attendee and non-attendee in chronological order with respect to uploader, popularity and presence of self in the media. The one or more attendee computing devices are connected to the system processing unit of the one or more cloud servers. The one or more attendee computing devices communicate with the system processing unit to receive invitation and event locations from the organizer computing device. The one or more attendee computing devices include an attendee display unit, an attendee camera. The attendee display unit is the interface between the one or more cloud servers and the attendee. The attendee display unit displays all the event-related artifacts that are being communicated to the one or more attendee computing devices. The attendee creates event-related artifacts through the attendee camera that are automatically uploaded to the one or more cloud server memory. The system processing unit organizes the event-related artifacts and shares them with attendees and non-attendee, and organizers in chronological order with respect to uploader, popularity and presence of self in the media. Herein, the system processing unit executes server computer-readable instructions to create a chat room for allowing both one-to-one and attendee group chats, that provides live feedback to the event organizer through real-time sentiment analysis of the chat by artificial intelligence-based model. Herein, the system, allows single touch capturing, uploading, and sharing of event-related artifacts among attendees, and non-attendee, and organizing and storing the media in the cloud in chronological order with respect to uploader, popularity and presence of self in the media. Herein, the system processing unit uses an artificial intelligence-based model that notes the average arrival time of attendees in comparison with attendees' location and recommends the best location for the convenience of attendees. Herein, the system processing unit uses an artificial intelligence-based model that analyses likes for pictures and then recommends attendees with the same categories of pictures. In an embodiment, the organizer computing device and the one or more attendee computing devices are, including but not limited to, a desktop computer, a laptop, a tab, a smartphone, and, a smartwatch. In an embodiment, the artificial intelligence-based model is trained from the data stored in the one or more cloud server memory that has been extracted from the organizer computing device and the one or more attendee computing devices/In an embodiment, event-related artifacts are, including but limited to, a photo, video, short video reels, chats, and comments, video call records. In an embodiment, artificial intelligence-based personal assistance models is a machine-learning models.

In an embodiment, a method for aggregating and sharing event-related artifacts, the method includes:
a method of creating, sharing, and archiving event-related artifacts, the method of having
the organizer computing device creates event-related artifacts through the organizer camera that is automatically uploaded to the at least one cloud server memory;
the attendee creates event-related artifacts through the attendee camera that are automatically uploaded to the cloud server memory; and
the system processing unit organizes the event-related artifacts and shares them with attendees and non-attendee, and organizer in chronological order with respect to uploader, popularity and presence of self in the media;
the system processing unit uses an artificial intelligence-based model that analyses likes for pictures and then recommends attendees with the same categories of the picture; and
the system processing unit archives all event-related artifacts including chat and comments in a single place, that is in the cloud server memory.

Herein, the system, allows single-touch capturing, uploading, and sharing of event-related artifacts among attendees, non-attendee, and organizers and storing the media in the cloud in chronological order with respect to uploader, popularity and presence of self in the media

In an embodiment, the artificial intelligence-based personal assistance model is being used by the system processing unit to execute the different tasks, the task includes:
a method of inviting attendees, the method of having creating an event and inviting friends using an existing contact list that is stored in the organizer computing device; and
creating custom groups of contacts in the organizer computing device with auto-generated RSVP(“Respond, if you please”) workflow; and
the attendee computing device communicates with the system processing unit to receive invitation and event location from the organizer computing device;
a method of sharing information of check-in by the attendee in real-time, the method having the attendee computing device live GPS location is communicated to the organizer computing device and to the system processing unit of the cloud server;
the system processing unit tracks GPS location of attendee in real-time;
as soon as the attendee reach the location of the event the system processing unit of the cloud server automatically confirmed the check-in of the attendee;
even the system processing unit send notifications to the attendee computing device and the organizer computing device regarding the check-in of an attendee at the event.
a method of getting feedback on the event in real-time
   the system processing unit executes server computer-readable instructions to create a chat room to which the attendee has access;
   the system processing unit allows both one-to-one chats between attendees as well as group chats among attendees;
   the artificial intelligence-based model performs the sentiment analysis of the chat;
   based on the sentiment analysis artificial intelligence-based model provides live feedback to the event organizer on the organizer's computing device.

In an embodiment, a method for aggregating and sharing event-related artifacts, the method includes:
a method of creating, sharing, and archiving event-related artifacts, the method of having
   the organizer computing device creates event-related artifacts through the organizer camera that is automatically uploaded to the at least one cloud server memory;
   the attendee creates event-related artifacts through the attendee camera that are automatically uploaded to the one or more cloud server memory; and
   the system processing unit organizes the event-related artifacts and shares them with attendees and non-attendee, and organizer in chronological order with respect to uploader, popularity and presence of self in the media;
   the system processing unit uses an artificial intelligence-based model that analyses likes for pictures and then recommends attendees with the same categories of the picture; and
   the system processing unit archives all event-related artifacts including chat and comments in a single place, that is in the one or more cloud server memory.

Herein, the system, allows single-touch capturing, uploading, and sharing of event-related artifacts among attendees, non-attendee, and organizers and storing the media in the cloud in chronological order with respect to uploader, popularity and presence of self in the media

In an embodiment, the artificial intelligence-based personal assistance model is being used by the system processing unit to execute the different tasks, the task includes:
a method of inviting attendees, the method of having
   creating an event and inviting friends using an existing contact list that is stored in the organizer computing device; and
   creating custom groups of contacts in the organizer computing device with auto-generated RSVP(“Respond, if you please”) workflow; and the one or more attendee computing devices communicate with the system processing unit to receive invitation and event location from the organizer computing device;
a method of sharing information of check-in by the attendee in real-time, the method having
   the one or more attendee computing devices live GPS location is communicated to the organizer computing device and to the system processing unit of the one or more cloud servers;
   the system processing unit tracks GPS location of attendee in real-time;
   as soon as the attendee reach the location of the event the system processing unit of the one or more cloud servers automatically confirmed the check-in of the attendee;
   even the system processing unit send notifications to the one or more attendee computing devices and the organizer computing device regarding the check-in of an attendee at the event.
a method of getting feedback on the event in real-time
   the system processing unit executes server computer-readable instructions to create a chat room to which the attendee has access;
   the system processing unit allows both one-to-one chats between attendees as well as group chats among attendees;
   the artificial intelligence-based model performs the sentiment analysis of the chat;
   based on the sentiment analysis artificial intelligence-based model provides live feedback to the event organizer on the organizer's computing device.

Further objectives, advantages, and features of the present invention will become apparent from the detailed description provided herein below, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim:

1. A system(100) and method for aggregating event-related artifacts and making artifacts accessible, the system(100) comprising:
an at least one cloud server(102), the at least one cloud server(102) having an at least one cloud server memory(104), the at least one cloud server memory(104) stores server computer-readable instructions, the credentials of an attendee that is invited to the event, event-related artifacts created by all the attendees for archiving and sharing, comments and chats of the attendee, and an artificial intelligence-based model, and
a system processing unit(106), the system processing unit(106) executes server-computer-readable instructions to train an artificial intelligence-based model and executes server computer-readable instructions to automatically archive and share event-related artifacts created by all the attendee, characterized in that the system processing unit(106) execute server-computer-readable instructions also to automatically provide the real-time information to event attendees and organizers regarding the check-in of attendee in the event;
an organizer computing device(110), the organizer computing device(110) is connected to the system processing unit(106) of the at least one cloud server(102), the organizer computing device(110) communicates with the system processing unit(106) to invite the attendee and hire vendors for management of the event, and
the organizer computing device(110) having
an organizer display unit(112), organizer display unit(112) is the interface between the at least one cloud server(102) and the organizer, the organizer display unit(112) displays all the data that is being communicated to the organizer computing device(110), and
an organizer camera(108), the organizer computing device(110) creates event-related artifacts through the organizer camera(108) that is automatically uploaded to the at least one cloud server memory(104) and the system processing unit(106) organize the event-related artifacts and shares with attendee and non-attendee in chronological order with respect to uploader, popularity and presence of self in the media:
an at least one attendee computing device(122), the at least one attendee computing device(122) is connected to the system processing unit(106) of the at least one cloud server(102), the at least one attendee computing device(122) communicates with the system processing unit(106) to receive invitation and event location from the organizer computing device(110), the at least one attendee computing device(122) having
an attendee display unit(114), the attendee display unit(114) is the interface between the of the at least one cloud server(102) and the attendee, the attendee display unit(114) displays all the event-related artifacts that are being communicated to the at least one attendee computing device(122);
an attendee camera (116), the attendee creates event-related artifacts through the attendee camera(116) that are automatically uploaded to the at least one cloud server memory(104), and the system processing unit(106) organize the event-related artifacts and shares them with attendee and non-attendee, and organizer in chronological order:
characterized in that, the system processing unit(106) executes server computer-readable instructions to create a chat room for allowing both one-to-one and attendee group chats, that provides live feedback to the event organizer through real-time sentiment analysis of the chat by artificial intelligence-based model, characterized in that, the system(100), allows single touch capturing, uploading, and sharing of event-related artifacts among attendees, and non-attendee, and organizer and storing the media in the cloud in chronological order with respect to uploader, popularity and presence of self in the media,
characterized in that, the system processing unit(106) uses an artificial intelligence-based model that notes the average arrival time of attendees in comparison with attendees' location and recommends the best location for the convenience of attendees,
characterized in that, the system processing unit (106) uses an artificial intelligence-based model that analyses likes for pictures and then recommends attendees with the same categories of pictures.

2. The system(100) as claimed in claim 1, wherein the organizer computing device(110) and the at least one attendee computing device(122) are selected from a desktop computer, a laptop, a tab, a smartphone, and, a smartwatch.

3. The system(100) as claimed in claim 1, wherein the artificial intelligence-based model is trained from the data stored in the at least one cloud server memory(104) that has been extracted from the organizer computing device(110) and the at least one attendee computing device (122)

4. The system (100) as claimed in claim 1, wherein, event-related artifacts are selected from a photo, video, short video reels, chats, and comments, video call records.

5. The system(100) as claimed in claim 1, wherein, artificial intelligence-based personal assistance models is a machine-learning models.

6. The system(100) as claimed in claim 1, wherein a method for aggregating and sharing event-related artifacts, the method comprising:
a method of creating, sharing, and archiving event-related artifacts, the method of having
the organizer computing device(110) creates event-related artifacts through the organizer camera(108) that is automatically uploaded to the at least one cloud server memory(104);
the attendee creates event-related artifacts through the attendee camera(116) that are automatically uploaded to the at least one cloud server memory(104); and
the system processing unit(106) organizes the event-related artifacts and shares them with attendees and non-attendee, and organizer in chronological order with respect to uploader, popularity and presence of self in the media:
the system processing unit(106) uses an artificial intelligence-based model that analyses likes for pictures and then recommends attendees with the same categories of the picture; and
the system processing unit(106) archives all event-related artifacts including chat and comments in a single place, that is in the at least one cloud server memory(104) characterized in that, the system(100), allows single-touch capturing, uploading, and sharing of event-related artifacts among attendees, non-attendee, and organizers and storing the media in the cloud in chronological order with respect to uploader, popularity and presence of self in the media

7. The system(100) as claimed in claim 1, wherein, the artificial intelligence-based personal assistance model is being used by the system processing unit(106) to execute the different tasks, the task comprising:
a method of inviting attendees, the method of having
creating an event and inviting friends using an existing contact list that is stored in the organizer computing device(110), and
creating custom groups of contacts in the organizer computing device(110) with auto-generated RSVP(“Respond, if you please”) workflow, and
the at least one attendee computing device(122) communicates with the system processing unit(106) to receive invitation and event location from the organizer computing device(110);
a method of sharing information of check-in by the attendee in real-time, the method having
the at least one attendee computing device(122) live GPS location is communicated to the organizer computing device(110) and to the system processing unit(106) of the at least one cloud server(102),
the system processing unit(106) tracks GPS location of attendee in real-time, as soon as the attendee reach the location of the event the system processing unit(106) of the at least one cloud server(102) automatically confirmed the check-in of the attendee; even the system processing unit(106) send notifications to the at least one attendee computing device(122) and the organizer computing device(110) regarding the check-in of an attendee at the event.
a method of getting feedback on the event in real-time
the system processing unit(106) executes server computer-readable instructions to create a chat room to which the attendee has access, the system processing unit(106) allows both one-to-one chats between attendees as well as group chats among attendees, the artificial intelligence-based model performs the sentiment analysis of the chat, based on the sentiment analysis artificial intelligence-based model provides live feedback to the event organizer on the organizer's computing device(110).
